(19) United States
(12) Patent Application Publication
(10) Pub. No.: US 2026/0027774 A1
(43) Pub. Date: Jan. 29, 2026

(54) A PRINTING PLATFORM FOR SUPPORTING AN OBJECT THAT IS MANUFACTURED FROM LAYERS OF MATERIAL EXTRUDED BY AN ADDITIVE MANUFACTURING NOZZLE AND A METHOD FOR PRODUCING AN OBJECT

(71) Applicant: CEAD IP B.V., DELFT (NL)

(72) Inventors: Jasper Vincent Maria WEGHORST, DELFT (NL); Jeroen VONK, DELFT (NL); Maarten Jan LOGTENBERG, DELFT (NL); Lucas Leonard Albertus JANSSEN, DELFT (NL)

(21) Appl. No.: 18/996,836

(22) PCT Filed: Jul. 13, 2023
(86) PCT No.: PCT/NL2023/050375

§ 371 Date: Jan. 17, 2025

(30) Foreign Application Priority Data
Jul. 21, 2022 (NL) 2032566

(51) Int. Cl. B29C 64/245; B29C 64/118; B33Y 10/00; B33Y 30/00

(52) U.S. Cl. CPC B29C 64/245; B29C 64/118; B33Y 10/00; B33Y 30/00

(57) ABSTRACT

The invention relates to a printing platform for supporting an object that is manufactured from layers of material extruded by an additive manufacturing nozzle and further to a method for producing an object that is manufactured from layers of material extruded by an additive manufacturing nozzle using such a printing platform.

The invention relates to a printing platform for supporting an object that is manufactured from layers of material extruded by an additive manufacturing nozzle and further to a method for producing an object that is manufactured from layers of material extruded by an additive manufacturing nozzle using such a printing platform.

A known problem in 3D printing is ensuring proper layer adhesion to the printing platform during the first layers of printing. Many users in the 3D printing industry struggle with this problem. Poor bonding between the printed object and the printing platform is mainly related to the shrinkage that occurs when the printed object cools down. The material used to build a printed object comes out of the extruder in liquid form at a high temperature (often between 200 and 400 degrees). Then the material solidifies as a result of cooling. This cooling is necessary to be able to print an object, but also causes shrinkage of the printed object. Due to the shrinkage the printed object will warp and tears itself loose from the printing platform. This poor bonding issues result in quality issues of the object being manufactured, in particular when printing large size objects due to large area solidification. Large size objects are objects with a minimum dimension of 0.5 meter or even 1 meter.

A known method is to print on top of wooden or plastic sheets to gain adhesion, see for example WO2017/176427. This document discloses to use a wooden foundation structure on the printing platform. However, this approach has disadvantages. For example, not all 3D printing materials adheres well to such an additional sheet, such that the choice of the 3D printing material being used is restricted.

It is an object of the present invention to provide an improved printing platform for example having improved layer adhesion.

This object is achieved by a printing platform as defined in claim 1.

The printing platform for supporting an object that is manufactured from layers of material extruded by an additive manufacturing nozzle comprises:

a platform body having multiple holes; and anchoring pins configured to be filled with material extruded by the additive manufacturing nozzle and each anchoring pin is adapted to be arranged in one of the holes of the platform body.

The new printing platform comprises a platform body having multiple holes, such as a top platform body surface with multiple holes, wherein anchoring pins are or can be arranged in the holes before the printing of the objects starts. The anchoring pins are configured to be filled with material extruded by the additive manufacturing nozzle. In other words, each anchoring pin is hollow from the inside and the additive manufacturing nozzle will fill the desired amount of pins during the first layer of the printing material. When the printed object starts to shrink and warp due to cooling down, the anchoring pins may for example mechanically be connected to the platform body as a result of the forces provided by material shrinkage. As a result, the printed object is fixed to the printing platform via the anchoring pins, i.e. the first layer of material remains in a fixed position by means of the anchoring pins in the holes of the platform body. The printing platform provides improved object quality, increased productive capacity as a result of lower failure rates and any flowable material suitable for additive manufacturing may be used for printing the object with the nozzle.

The anchoring pins or at least one part of each anchoring pin which is in direct contact with printing material can be made of or coated with a material that provides excellent layer adhesion with the selected printing material, such that the selected printing material inside the anchoring pin cannot be pulled out by external process forces, for example forces provided by the above described shrinkage process. In other words, a material or coating such that the printing material may be anchored in an interior space of the anchoring pin. The insertable anchoring pins enable various types of anchoring pins to be provided, wherein each type can be tailored with respect to the anchoring material or anchoring coating to the desired printing material. Hence, the choice of the 3D printing material is not restricted, i.e. in theory perhaps even unrestricted. The platform body itself may not require modifications for using different types of anchoring pins, for example anchoring pins with different coatings for anchoring different printing materials to the anchoring pins, because the outer shape of the different types of anchoring pins may have a universal shape, i.e. a standard design to be arranged in at least a portion of one of the holes of the platform body. The anchoring pins may be fixed or releasable attached in the holes of the platform body.

In one aspect, each hole extends through the platform body from a top to a bottom of the platform body. Such a hole configuration, wherein the hole extends through the platform body provides more possibilities for fixing the anchoring pin to the platform body as will be discussed below. In addition, the holes may be arranged in a pattern which, seen from above, is defined by rows of holes and/or columns of holes. Such a pattern, may be a standard pattern, providing relatively much flexibility for producing different objects with the printing platform, i.e. independent of size or shape of the object to be manufactured. The platform body is configured to “anchor” the first layer of printing material of the object to the printing platform by means of the anchoring pins inserted in at least a part of the holes of the platform body.

In a further aspect, the anchoring pins are connected in the holes by means of a frictional connection and/or by means of a positive-fit connection. An advantage of mechanical bonding each anchoring pin to the printing platform is that the choice of 3D printing material is no longer directly dependent on the material of the printing platform being printed on. A frictional connection can be provided in a relatively simple manner in that the pins and the holes do not require special measures or means for the mechanical connection. For example, after the desired amount of pins has been filled during the first layer of the printing by the additive manufacturing nozzle, the material of the first layer starts to shrink and warp due to cooling down, wherein the anchoring pins connected to each other by printing material will be skewed and pushed against the walls of the holes in the platform body, such that the pins clamp themselves to the platform body, i.e. a connection by friction. A positive-fit connection requires additional measures or means to provide the mechanical connection. Each anchoring pin may be provided with at least one hook-like member for providing the positive-fit connection. For example, each anchoring pin comprises a lower part and an upper part, wherein the lower part can be provided with the at least one hook-like member for providing the positive-fit connection for example with the bottom surface of the platform body. The at least one hook-like member may be adapted to move between an anchoring position for anchoring the anchoring pin to the platform body and an introduction position for introducing the anchoring pin in the hole, and optionally vice versa, wherein in the anchoring position the at least one hook-like member extends more outwardly seen from the centre line of the anchoring pin with respect to an outer anchoring pin side surface than in the introduction position. Such an anchoring pin having this hook-like member can be inserted easily into the hole as a result of movement into the introduction position during insertion into the hole and after insertion the hook-like member may return, for example automatically, to the anchoring position for providing a positive-fit connection between the anchoring pin and the platform body. Alternatively or in addition, the anchoring pin may be provided with at least one fixation hole in an outer anchoring pin side surface, wherein the fixation hole is adapted for receiving a fixation element for providing the positive-fit connection. The fixation element may be an external fastening element which can be positioned in the fixation hole of the anchoring pin for anchoring the anchoring pin against a bottom surface of the platform body. It is also possible that the fixation hole is a fixation through hole extending between opposite outer anchor pin side surfaces, wherein the fixation element to be inserted is able to extend through the anchor pin.

In another aspect, each anchoring pin comprises an interior space which can be filled with material extruded by the additive manufacturing nozzle, wherein the interior space has a non-releasing printing material configuration. Such a non-releasing printing material configuration of the interior space ensures that the printing material cannot be pulled out of the anchoring pin. The non-releasing printing material configuration provides flexibility to choose how the printing material will be anchored in the interior space, such that the printed object can be broken free from the printing platform when the object has been printed. The non-releasing printing material configuration is provided by the interior space designed to provide a positive-fit connection with the material extruded by the additive manufacturing nozzle, for example an inner wall of the interior space comprises at least one recess. The exact shape of the interior space for providing the non-releasing printing material configuration may vary. Alternatively of in addition, the non-releasing printing material configuration may comprise at least one material outflow opening in the interior space. The interior space can be filled with printing material by means of the nozzle, and the printing material will then flow out the at least one material outflow opening. After the material that has flown out solidifies, the material itself provides a hook which anchors the anchoring pin against a bottom surface of the platform body.

It is also an object of the present invention to provide a method for producing an object that is manufactured from layers of material extruded by an additive manufacturing nozzle in an improved manner.

This object is achieved by using a method as defined in the method claims.

The method for producing an object that is manufactured from layers of material extruded by an additive manufacturing nozzle uses a printing platform of this disclosure. For the sake of brevity and to avoid duplication, the features and/or advantages of the printing platform as mentioned in this disclosure will not be repeated here.

The method may comprise at least the following steps:
a) filling a first anchoring pin of the anchoring pins with material extruded by the additive manufacturing nozzle;
b) moving the additive manufacturing nozzle to a second anchoring pin of the anchoring pins while extruding material;
c) filling the second anchoring pin with material extruded by the additive manufacturing nozzle. Hence, the interior spaces of the first and second anchoring pins arranged in holes of the platform body are advantageously connected to each other by means of material extruded by the additive manufacturing nozzle, in particular the first layer of the object.

The steps b) and c) may be repeated for other anchoring pins which cover a footprint of the object being manufactured. The method provides improved object quality, increased throughput and any flowable material suitable for additive manufacturing may be used for printing the object with the nozzle.

In one aspect of the method, the filled anchoring pins are connected in the holes by means of shrinkage forces of the extruded material. For example, due to the shrinkage forces in at least the first layer connecting the printing material inside the anchoring pins, the anchoring pins can be moved and clamped inside the holes. Alternatively or in addition, each filled anchoring pin comprises at least one material outflow opening such that anchoring pins are connected to or in the holes by means of a positive-fit connection provided by the extruded material which has flown through the at least one material outflow opening.

The printing platform and the method of this disclosure are in particular suited for printing large scale objects or object parts. For example, the minimum dimension of the object is 0.5 meter, or even at least 1 meter and/or the minimum horizontal (X-Y) dimension of the footprint of the object is 0.5 meter, or even at least 1 meter.

The above-described aspects will be explained below by means of exemplary embodiments in combination with the figures. However, the invention is not limited to the exemplary embodiments described below. Rather, a number of variants and modifications are possible which also use the inventive idea and therefore fall within the scope of protection. In particular, the possibility of combining the features/aspects which are only mentioned in the description and/or shown in the figures with the features of the claims, in so far as compatible, is mentioned.

Reference is made to the following figures, in which:

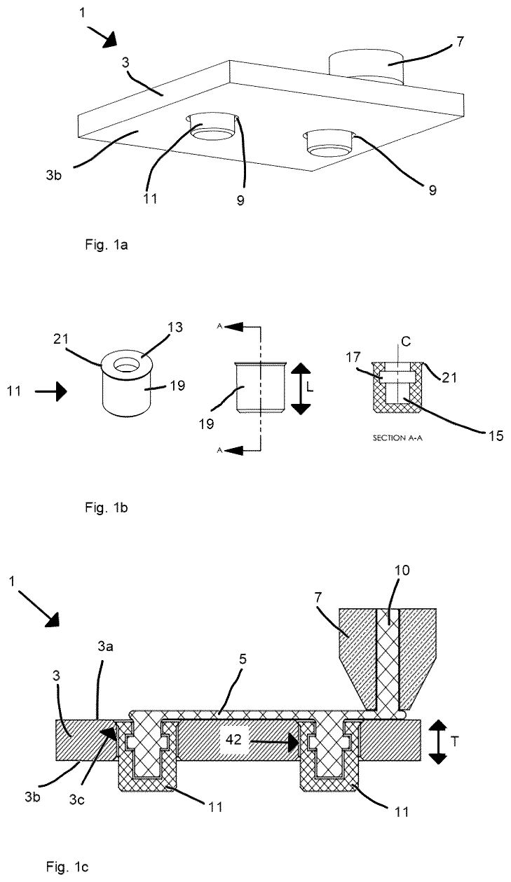

FIG. 1a-c show various views of the printing platform including parts thereof and method steps according to a first embodiment;

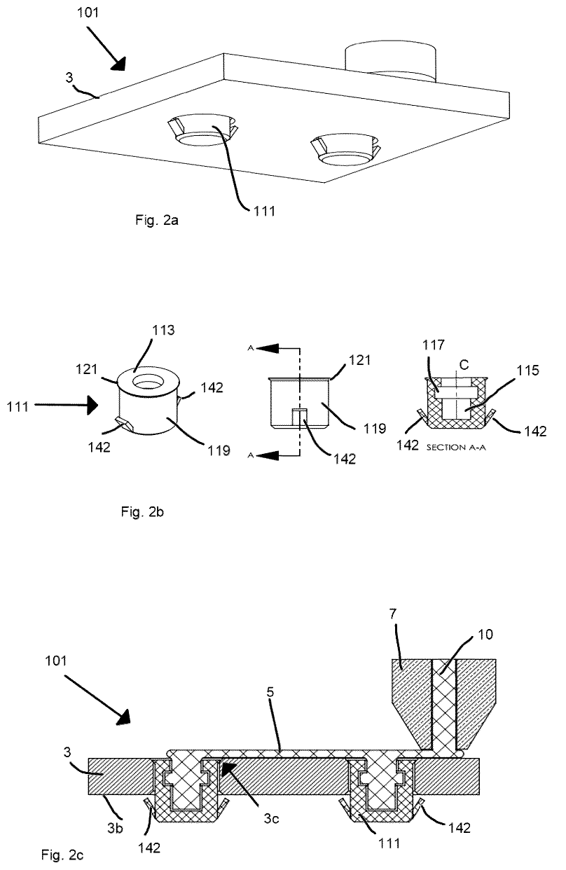

FIG. 2a-c show various views of the printing platform including parts thereof and method steps according to a second embodiment;

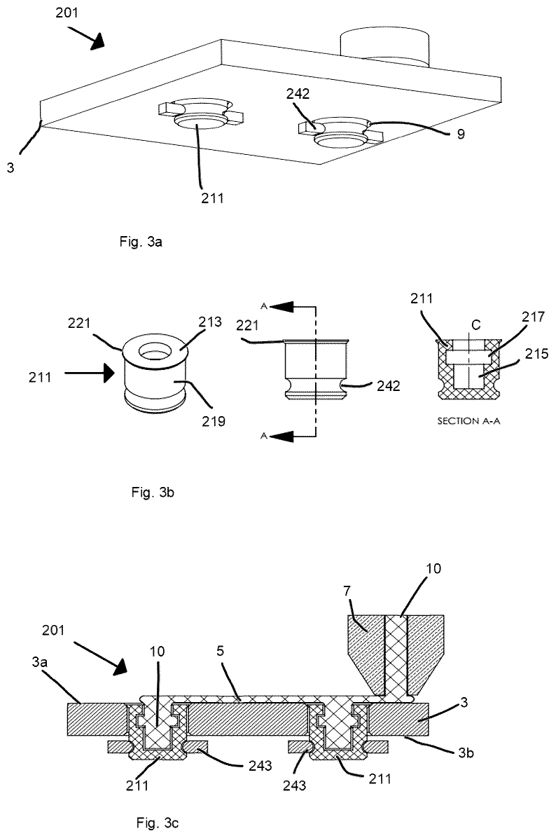

FIG. 3a-c show various views of the printing platform including parts thereof and method steps according to a third embodiment;

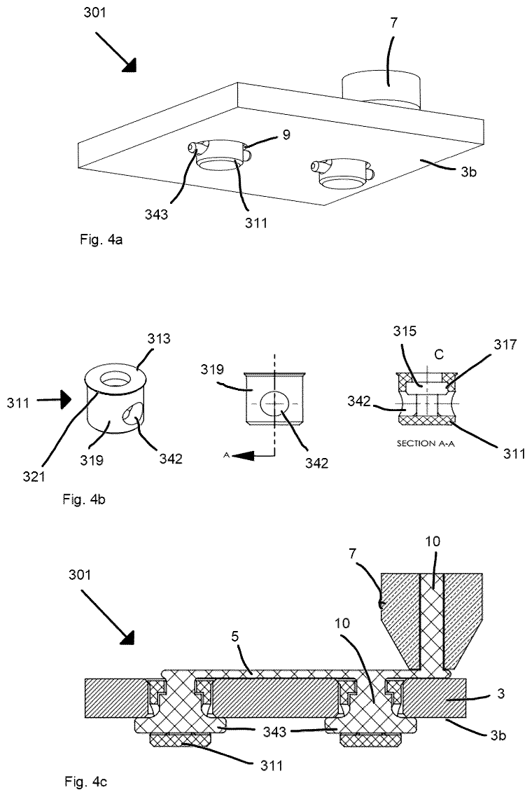

FIG. 4a-c show various views of the printing platform including parts thereof and method steps according to a fourth embodiment. In the figures, identical components are provided with identical reference signs.

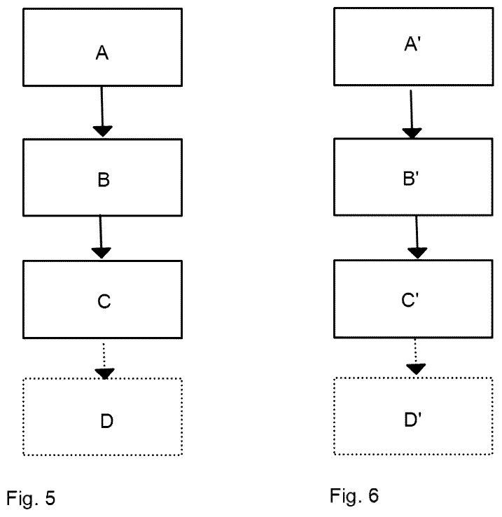

FIGS. 5 and 6 show flow charts of the method steps for producing an object.

The FIGS. 1a-4c show a printing platform 1; 101; 201; 301 for supporting an object that is manufactured from layers 5 of material extruded by an additive manufacturing nozzle 7. In the figures only the first layer 5 of the object has been shown. A machine having a configuration as shown in FIG. 1 of WO2017/176427 may for example by used, preferably without a roller (identified with reference sign 59 in the drawings of WO2017/176427), wherein the worktable of WO2017/176427 identified with reference 27 in FIG. 1 is substituted by the printing platform 1; 101; 201; 301 of this disclosure.

The printing platform 1; 101; 201; 301 comprises a platform body 3 having multiple holes. In the figures each platform body 3 only comprises two holes 9 as an example and for illustrative purposes only. The platform body 3 will normally have more holes 9 than two, for example at least ten holes. Normally, the holes 9 are arranged in a pattern which, seen from above, is defined by rows of holes as shown in the figures, and/or columns of holes (not shown). For example, a platform body (not shown) of the printing platform of this disclosure with a row-column pattern of at least ten by ten holes may be used for printing the object. Such a standard pattern of holes provides the possibility to deal with a relatively large number of objects having different footprints.

The printing platform 1; 101; 201; 301 further comprises anchoring pins 11; 111; 211; 311 configured to be filled with material extruded by the additive manufacturing nozzle and each anchoring pin 11; 111; 211; 311 is adapted to be arranged in at least a portion of one of the holes 9 of the platform body 3. The anchoring pins 11; 111; 211; 311 may be fixed or releasable attached in the holes 9 of the platform body 3. It is also possible to use a combination of anchoring pins in one platform body, for example a platform body 3 comprising the anchoring pin 111 shown in FIG. 2b as the first anchoring pin and the anchoring pin 211 shown in FIG. 3b as the second anchoring pin.

As can be seen, each hole 9 extends through the platform body 3 from a top 3a to a bottom 3b of the platform body 3. Each anchoring pin 11; 111; 211; 311 has a length L (FIG. 1b) which is larger than the thickness T (FIG. 1c) of the platform body 3, wherein a top side 13; 113; 213; 313 of each anchoring pin 11; 111; 211; 311 is substantially flush with the top surface 3a of the platform body, such that each anchoring pin 11; 111; 211; 311 protrudes with respect to the bottom surface 3b of the platform body 3, as can be seen in the figures. It is also possible to use a blind hole (not shown) instead of a through hole as shown in the drawings and/or it is possible that the anchoring pin 11; 111; 211; 311 has a length equal or smaller than the thickness T of the platform body 3.

Each anchoring pin 11; 111; 211; 311 comprises a top edge of the anchoring pin between a side surface 19; 119; 219; 319 of the anchoring pin and the top 13; 113; 213; 313 of the anchoring pin, wherein the top edge is provided with an outwardly extending flange 21; 121; 221; 321 seen from the centre line C of the anchoring pin with respect to an outer anchoring pin side surface 19; 119; 219; 319. The outer anchoring pin side surface 19; 119; 219; 319 is a substantially cylindrical outer anchoring pin side surface 19; 119; 219; 319. Instead of a cylindrical anchoring pin 11; 111; 211; 311, other shapes are also possible. The shape of the hole for a specific shaped anchoring pin is preferably complementary.

The platform body 3 comprises upper edges 3c between each hole 9 and a top 3a of the platform body 3, wherein each upper edge is a bevelled edge 3c. The flange 21; 121; 221; 321 of each anchoring pin 11; 111; 211; 311 and the bevelled edge 3c of each hole 9 are complementary shaped such that a top surface 13; 113; 213; 313 of the anchoring pin supported by the bevelled edge 3c is flush with at least a portion of the top 3a of the platform 3 around the hole 9. In addition, the flange 21; 121; 221; 321 and the bevelled edge 3c ensure that the anchoring pin is connected and/or positioned in each hole 9 correctly.

Each anchoring pin 11; 111; 211; 311 comprises an interior space 15; 115; 215; 315 which can be filled with material 10 extruded by the additive manufacturing nozzle 7, wherein the interior space has a non-releasing printing material configuration.

The interior space 15; 115; 215; 315 may be designed to provide a positive-fit connection with the material extruded by the additive manufacturing nozzle 7, i.e. a non-releasing printing material configuration. In particular, the interior space 15; 115; 215 comprises an inner wall of the interior space having at least one circumferential recess 17; 117; 217. Various shapes of the interior space 15; 115; 215 are possible to obtain a non-releasing printing material configuration. The interior space 315 of anchoring pin 311 is for example provided with openings 342 for providing a positive-fit connection with the material extruded by the additive manufacturing nozzle 7.

The non-releasing printing material configuration of the anchoring pin 311 comprises at least one material outflow opening 342 in the interior space 315. As shown in FIG. 4c, the printing material 10 that has flown out the material outflow openings 342 solidifies, such that the material 10 itself provides a printing material hook 343 which anchors the anchoring pin 311 against a bottom surface 3b of the platform body 3 and simultaneously anchors the solidified material 10 to the anchoring pin 311. The printing material 10 flowing out of the material outflow opening has a double function, i.e. fixating or anchoring the anchoring pin 311 to the platform body 3 and fixating or anchoring the (solidified) printing material to the anchoring pin 311.

The anchoring pins 11 shown in FIGS. 1a-c are connected in the holes 9 by means of a frictional connection. A frictional connection can be provided in a relatively simple manner in that the pins 11 and the holes 9 do not require special measures or means for providing a mechanical connection between the anchoring pins and the platform body. After filling the pins 11, the first layer 5 of the printing material connects the two pins 11. The material of the first layer 5 then starts to shrink and warp due to cooling down, wherein the anchoring pins 11 connected to each other by printing material will be skewed and pushed against the walls of the holes in the platform body 3, such that the two pins 11 clamp themselves to the platform body 3, i.e. a connection 42 by friction. The printing platform 1 has a configuration which allows to use the printing material itself to obtain an improved first layer adhesion to the printing platform 3 during printing which results inter alia in an improved object quality.

The anchoring pins 111 shown in FIGS. 2a-c are connected in the holes 9 by means of a positive-fit connection. These anchoring pins 111 can be fixed to the platform body 3 independent of the printing material, in that each anchoring pin 111 is provided with two hook-like members 142. It is also possible that the hook-like members 142 will be hooked to the bottom surface 3b of the platform body 3 in response to shrinkage forces in the first layer 5. The two hook-like members 142 are adapted to move between an anchoring position (shown in FIGS. 2a-c) for anchoring the anchoring pin 111 to the platform body 3 and an introduction position (not shown) for introducing the anchoring pin 111 in the hole 9, and optionally vice versa. In the anchoring position the hook-like members 142 extend more outwardly seen from the centre line C of the anchoring pin 111 with respect to an outer anchoring pin side surface 119 than in the introduction position.

The anchoring pins 211 shown in FIGS. 3a-c are also connected in the holes 9 by means of a positive-fit connection. The anchoring pin 211 is provided with two spaced fixation holes 242, wherein each fixation hole 242 is adapted for receiving an external fixation element 243 for providing the positive-fit connection in a manner which is similar as described in relation to the embodiment of FIG. 2a-c.

The FIGS. 1c, 2c, 3c and 4c show details of the method for producing an object that is manufactured from layers of material extruded by an additive manufacturing nozzle 7 using a printing platform 1; 101; 201; 301. At least the following steps can be derived from these figures:
a) filling a first anchoring pin 11; 111; 211; 311 of the anchoring pins with material 10 extruded by the additive manufacturing nozzle 7 (Step A in FIG. 5);
b) moving the additive manufacturing nozzle to a second anchoring pin 11; 111; 211; 311 of the anchoring pins while extruding material 10 (Step B in FIG. 5);
c) filling the second anchoring pin 11; 111; 211; 311 with material 10 extruded by the additive manufacturing nozzle 7 (Step C in FIG. 5).

The steps b) and c) may be repeated (Step D in FIG. 5) for other anchoring pins 11; 111; 211; 311 which cover a footprint of the object being manufactured.

Each anchoring pin may have more than one opening for filling with material extruded by the additive manufacturing nozzle. Each anchoring pin may further have a rectangular cross section, instead of a circular cross section as shown in the drawings.

The platform body is a one-piece platform body 3, i.e. a solid plate-like platform body 3 provided with holes 9. It is also possible to use the one-piece platform body 3 without anchoring pins 11; 111; 211; 311 in a method for producing an object to be discussed below. The platform body 3 may have holes 9 as shown and described in this document, but it is also possible to use different shaped holes, for example a hole or at least a portion of a hole having at least one edge extending between planar inner walls of the hole such as a square or triangular (in cross section) shaped hole or hole portion instead of the cylindrical holes 9 having a constant cross section as shown in the figures and/or a blind hole as mentioned above. The adhesion process of the printing material to inner wall(s) or wall portion(s) of the hole may be increased by using a hole having at least two differently shaped portions. It is for example possible to provide a hole having at least two cylindrical portions, wherein each cylindrical portion has a different diameter, preferably the portion with the smaller diameter is positioned further away from the top surface of the platform body than the portion with the larger diameter. Each hole 9 extends through the platform body 3 from a top to a bottom of the platform body. A hole, for example hole 9, has an interior hole space, wherein various shapes of the interior hole space are possible to obtain a non-releasing printing material configuration or an improved non-releasing printing material configuration. The hole may for example have a hole portion with at least one circumferential recess like recess 17; 117; 217 of the pin in the figures. The inner wall(s) of the hole may be coated with a coating material that provides improved material adhesion with the selected printing material, such that the selected printing material inside the hole adheres relatively quickly. By means of the coating it is more difficult that the selected printing material inside the hole can be pulled out by external process forces, for example forces provided by the above described shrinkage process. In other words, a coating such that the printing material may be anchored in an interior space of the hole.

In this method for producing an object that is manufactured from layers of material extruded by an additive manufacturing nozzle 7 using a platform body, for example a platform body as described in the preceding paragraph or platform body 3, the method comprises at least the following steps:
a) filling a first hole of the platform body with material 10 extruded by the additive manufacturing nozzle 7 with a predefined volume and a predefined flow velocity (Step A′ in FIG. 6),
b) moving the additive manufacturing nozzle to a second hole of the platform body (Step B′ in FIG. 6);
c) filling the second hole of the platform body with material 10 extruded by the additive manufacturing nozzle 7 with a predefined volume and a predefined flow velocity (Step C′ in FIG. 6).

During the filling step of step a) and/or step c) the nozzle will move upwards, for example starting at a first height, for example at the height of the opening of the hole or just above the opening of the hole, to a predetermined second height, for example the difference between the first height and the predetermined second height is at most 2 cm, preferably at most 1 cm, more preferred at most 5 mm. The movement for filling the hole may be strictly vertical. By moving the nozzle upwards, the printing material is subjected longer to the environment before reaching the hole, such that the printing material has for example a lower temperature in the hole which may improve the adhesion process to the inner hole walls. The steps b) and c) may be repeated (Step D′ in FIG. 6) for other holes of the platform body which cover a footprint of the object being manufactured. During and/or before the filling steps b) and c) the temperature of platform body may be controlled, for example completely or locally around the hole to be filled and/or being filled, wherein depending on the printing material being used the temperature may be lowered and/or raised. The temperature control process of the platform body may be provided by a temperature control mechanism, for example a heating mechanism, in the platform body and/or by an external temperature control unit, for example by means of a printer head comprising the nozzle and the temperature control unit such as a heating unit. The predefined flow velocity for filling a hole with printing material is at least 3 kg/hour. The printing material may be a thermoplastic, preferably a thermoplastic fiber reinforced material with a fiber percentage of at least 10%, more preferred at least 15%.

1. A printing platform for supporting an object that is manufactured from layers of material extruded by an additive manufacturing nozzle, the printing platform comprising:
a platform body having multiple holes; and
anchoring pins configured to be filled with material extruded by the additive manufacturing nozzle and each anchoring pin is adapted to be arranged in one of the holes of the platform body.

2. A printing platform according to claim 1, wherein each hole extends through the platform body from a top to a bottom of the platform body.

3. A printing platform according to claim 1, wherein the holes are arranged in a pattern which, seen from above, is defined by rows of holes and/or columns of holes.

4. A printing platform according to claim 1, wherein the anchoring pins are connected in the holes by means of a frictional connection.

5. A printing platform according to claim 1, wherein the anchoring pins are connected in the holes by means of a positive-fit connection.

6. A printing platform according to claim 5, wherein each anchoring pin is provided with at least one hook-like member.

7. A printing platform according to claim 6, wherein the at least one hook-like member is adapted to move between an anchoring position for anchoring the anchoring pin to the platform body and an introduction position for introducing the anchoring pin in the hole, and optionally vice versa, wherein in the anchoring position the at least one hook-like member extends more outwardly seen from the centre line of the anchoring pin with respect to an outer anchoring pin side surface than in the introduction position.

8. A printing platform according to claim 1, wherein each anchoring pin is provided with at least one fixation hole in an outer anchoring pin side surface, wherein the fixation hole is adapted for receiving a fixation element for providing the positive-fit connection.

9. A printing platform according to claim 1, wherein each anchoring pin comprises an interior space which can be filled with material extruded by the additive manufacturing nozzle, wherein the interior space has a non-releasing printing material configuration.

10. A printing platform according to claim 9, wherein the non-releasing printing material configuration is provided by the interior space designed to provide a positive-fit connection with the material extruded by the additive manufacturing nozzle, for example an inner wall of the interior space comprises at least one recess.

11. A printing platform according to claim 9, wherein the non-releasing printing material configuration comprises at least one material outflow opening in the interior space.

12. A printing platform according to claim 1, wherein a top edge of the anchoring pin between a side surface of the anchoring pin and the top of the anchoring pin is provided with an outwardly extending flange seen from the centre line of the anchoring pin with respect to an outer anchoring pin side surface, preferably a substantially cylindrical outer anchoring pin side surface.

13. A printing platform according to claim 1, wherein the platform body comprises upper edges between each hole and a top of the platform body, wherein each upper edge is a bevelled edge.

14. A printing platform according to claim 12, wherein the flange and the bevelled edge are complementary shaped such that a top surface of the anchoring pin supported by the bevelled edge is substantially flush with at least a portion of the top of the platform around the hole.

15. A method for producing an object that is manufactured from layers of material extruded by an additive manufacturing nozzle using a printing platform according to claim 1.

16. The method of claim 15, wherein the method comprises at least the following steps:
a) filling a first anchoring pin of the anchoring pins with material extruded by the additive manufacturing nozzle;
b) moving the additive manufacturing nozzle to a second anchoring pin of the anchoring pins while extruding material;
c) filling the second anchoring pin with material extruded by the additive manufacturing nozzle.

17. The method of claim 16, wherein the steps b) and c) are repeated for other anchoring pins which cover a footprint of the object being manufactured, preferably the minimum horizontal (X-Y) dimension of the footprint is 0.5 meter.

18. The method of claim 16, wherein the filled anchoring pins are connected in the holes by means of shrinkage forces of the extruded material.

19. The method of claim 16, wherein each filled anchoring pin comprises at least one material outflow opening such that anchoring pins are connected to or in the holes by means of a positive-fit connection provided by the extruded material which has flown through the at least one material outflow opening.
